(19) United States
(12) Patent Application Publication
(10) Pub. No.: US 2024/0078710 A1
(43) Pub. Date: Mar. 7, 2024

(54) METHOD, APPARATUS AND STORAGE MEDIUM FOR ENCODING/DECODING USING TRANSFORM-BASED FEATURE MAP

(71) Applicant: Electronics and Telecommunications Research Institute, Daejeon (KR)

(72) Inventors: Youn-Hee KIM, Daejeon (KR); Jooyoung LEE, Daejeon (KR); Se-Yoon JEONG, Daejeon (KR); Jin-Soo CHOI, Daejeon (KR); Dong-Gyu SIM, Seoul (KR); Na-Seong KWON, Seoul (KR); Seung-Jin PARK, Guri-si Gyeonggi-do (KR); Min-Hun LEE, Uijeongbu-si Gyeonggi-do (KR); Han-Sol CHOI, Dongducheon-si Gyeonggi-do (KR)

(73) Assignee: Electronics and Telecommunications Research Institute, Daejeon (KR)

(21) Appl. No.: 18/460,354

(22) Filed: Sep. 1, 2023

(30) Foreign Application Priority Data
Sep. 2, 2022 (KR) 10-2022-0111660
Aug. 30, 2023 (KR) 10-2023-0114548

(51) Int. Cl. G06T 9/00; G06T 3/40

(52) U.S. Cl. CPC G06T 9/00; G06T 3/40

(57) ABSTRACT

Disclosed herein are a method, an apparatus and a storage medium for encoding/decoding using a transform-based feature map. An optimal basis vector is extracted from one or more feature maps, and a transform coefficient is acquired through a transform using the basis vector. The basis vector and the transform coefficient may be transmitted through a bitstream. In an embodiment, one or more feature maps are reconstructed using the basis vector and the transform coefficient, which are decoded from the bitstream.

### CROSS REFERENCE TO RELATED APPLICATIONS

This application claims priority under 35 U.S.C. § 119(a) to Korean Patent Application Nos. 10-2022-0111660, filed Sep. 2, 2022, and 10-2023-0114548, filed Aug. 30, 2023, in the Korean Intellectual Property Office, which are hereby incorporated by reference in their entireties into this application.

### BACKGROUND OF THE INVENTION

### 1. Technical Field

The present disclosure relates to a method for encoding/decoding a feature map, and more particularly to a method, an apparatus and a storage medium for encoding/decoding a transform-based feature map.

### 2. Description of the Related Art

As industrial fields to which deep-neural networks using deep learning are applied are expanded, there is a growing trend of applying deep-neural networks to industrial machinery.

In order to use deep-neural networks for applications which utilize communication between machines, research into a compression method in which not only human visual characteristics but also characteristics playing an important role in deep-neural networks provided in the machines are taken into consideration has been actively conducted.

Generally, a feature map in the intermediate layer of each deep-learning network has a larger amount of data than that of an input image.

Therefore, there is required technology for improving the compression efficiency of the feature map having a large amount of data and reducing the amount of data to be processed.

### SUMMARY OF THE INVENTION

An embodiment is intended to provide a method, an apparatus and a storage medium for encoding/decoding a transform-based feature map.

An embodiment is intended to provide transform-based encoding on one or more feature maps that are the targets of compression.

An embodiment is intended to provide a method for extracting an optimal basis vector from one or more feature maps and acquiring a transform coefficient through a transform that uses the basis vector.

An embodiment is intended to provide a method for transmitting a bitstream including a basis vector and a transform coefficient.

An embodiment is intended to provide a method for receiving a bitstream including a basis vector and a transform coefficient.

An embodiment is intended to provide a method for acquiring a decoded basis vector and a decoded coefficient from a bitstream.

An embodiment is intended to provide a method for generating one or more reconstructed feature maps from a bitstream using a decoded basis vector and a decoded coefficient.

An embodiment is intended to provide a method for deriving the final result of a deep-learning network through a machine vision task executer that uses a reconstructed feature map.

An embodiment is intended to provide a method for utilizing a fixed common basis vector or a fixed common transform coefficient for one or more feature maps.

An embodiment is intended to provide a method for utilizing a fixed common basis vector or a transform coefficient, which is defined through an agreement between an encoding apparatus and a decoding apparatus.

In accordance with an aspect, there is provided an encoding method, including extracting a feature map from an input image; acquiring feature map information from the feature map; and generating a bitstream by performing encoding on the feature map information.

The feature map information may include at least one of a basis vector or a transform coefficient, or a combination thereof.

A basis vector of the feature map may be derived using the feature map.

A transform coefficient may be derived by performing a transform on the feature map based on the basis vector.

A fixed basis vector of the feature map may be derived using the feature map information, and a transform that uses the fixed basis vector is performed on the feature map.

A common transform coefficient may be generated by performing the transform that uses the fixed basis vector on the feature map.

A joined feature map may be generated by joining multiple reconfigured feature maps.

The joined feature map may be used to derive the fixed basis vector.

At least one of quantization or packing, or a combination thereof may be performed on the feature map information.

At least one of the quantization or the packing, or a combination thereof may be skipped depending on a type of the feature map information.

The feature map may include multiple feature maps having different resolutions.

In accordance with another aspect, there is provided a computer-readable storage medium for storing a bitstream generated by the encoding method.

In accordance with a further aspect, there is provided a decoding method, including acquiring feature map information from a bitstream; and acquiring a feature map from the feature map information.

The feature map information may include at least one of a basis vector or a transform coefficient, or a combination thereof.

The feature map may be reconstructed by performing an inverse transform that uses at least one of the basis vector or the transform coefficient, or a combination thereof.

The feature map may be reconstructed by performing an inverse transform that uses at least one of a fixed basis vector or a fixed transform coefficient of the feature map, or a combination thereof.

The bitstream may include at least one of the fixed basis vector or the fixed transform coefficient, or a combination thereof.

At least one of inverse packing or inverse quantization or a combination thereof may be performed on the feature map information.

At least one of the inverse-quantization or the inverse-packing or a combination thereof may be skipped depending on a type of the feature map information.

The feature map may include multiple feature maps having different resolutions.

The decoding method may further include deriving a result of a deep-learning network by executing a machine-vision task using the feature map.

In accordance with yet another aspect, there is provided a computer-readable storage medium for storing a bitstream for image decoding, wherein the bitstream includes feature map information, and a feature map is acquired from the feature map information.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 illustrates an image-processing system according to an embodiment;

FIG. 2 is a configuration diagram of an encoding apparatus according to an embodiment;

FIG. 3 is a flowchart illustrating a feature map extraction and encoding method according to an embodiment;

FIG. 4 illustrates the structure of a feature map extractor according to an embodiment;

FIG. 5 is a block diagram of a feature map transformer according to an embodiment;

FIG. 6 is a flowchart of a feature map transform method according to an embodiment;

FIG. 7 is a block diagram of a feature map transformer according to an embodiment;

FIG. 8 is a flowchart of a feature map transform method according to an embodiment;

FIG. 9 is a block diagram of a feature map transformer according to an embodiment;

FIG. 10 is a flowchart of a feature map transform method according to an embodiment;

FIG. 11 illustrates a process in which a joined feature map is generated from multiple images according to an example;

FIG. 12 is a block diagram of a feature map transformer for generating feature data according to an embodiment;

FIG. 13 illustrates a feature data generation method for deriving a fixed basis vector or a fixed transform coefficient according to an embodiment;

FIG. 14 illustrates the operation of a transform unit according to an embodiment;

FIG. 15 illustrates a feature map transform process using a fixed basis vector according to an embodiment;

FIG. 16 illustrates the operation of a transform unit according to an embodiment;

FIG. 17 illustrates a feature map transform process using a fixed common basis vector according to an embodiment;

FIG. 18 illustrates the operation of a transform unit according to an embodiment;

FIG. 19 illustrates a feature map transform process using a fixed transform coefficient according to an embodiment;

FIG. 20 illustrates the operation of a transform unit according to an embodiment;

FIG. 21 illustrates a feature map transform process using a fixed common transform coefficient according to an embodiment;

FIG. 22 illustrates a process of encoding a basis vector according to an embodiment;

FIG. 23 is a flowchart illustrating a method for encoding a basis vector according to an embodiment;

FIG. 24 illustrates a process for encoding a common basis vector according to an embodiment;

FIG. 25 is a flowchart illustrating a method for encoding a common basis vector according to an embodiment;

FIG. 26 illustrates a process of encoding a transform coefficient according to an embodiment;

FIG. 27 is a flowchart illustrating a method for encoding a transform coefficient according to an embodiment;

FIG. 28 illustrates a process of encoding a common transform coefficient according to an embodiment;

FIG. 29 is a flowchart illustrating a method for encoding a common transform coefficient according to an embodiment;

FIG. 30 is a configuration diagram of a decoding apparatus according to an embodiment; and

FIG. 31 is a flowchart illustrating a feature map decoding and machine vision task execution method according to an embodiment.

### DESCRIPTION OF THE PREFERRED EMBODIMENTS

The present disclosure may have various changes and various embodiments, and specific embodiments will be illustrated in the attached drawings and described in detail below. However, this is not intended to limit the present disclosure to particular modes of practice, and it is to be appreciated that all changes, equivalents, and substitutes that do not depart from the spirit or technical scope of the present disclosure are encompassed in the present disclosure.

Detailed descriptions of the following exemplary embodiments will be made with reference to the attached drawings illustrating specific embodiments. These embodiments are described so that those having ordinary knowledge in the technical field to which the present disclosure pertains can easily practice the embodiments. It should be noted that the various embodiments are different from each other, but are not necessarily mutually exclusive from each other. For example, specific shapes, structures, and characteristics described herein may be implemented as other embodiments without departing from the spirit and scope of the embodiments in relation to an embodiment. Further, it should be understood that the locations or arrangement of individual components in each disclosed embodiment can be changed without departing from the spirit and scope of the embodiments. Therefore, the accompanying detailed description is not intended to restrict the scope of the disclosure, and the scope of the exemplary embodiments is limited only by the accompanying claims, along with equivalents thereof, as long as they are appropriately described.

In the drawings, similar reference numerals are used to designate the same or similar functions in various aspects. The shapes, sizes, etc. of components in the drawings may be exaggerated to make the description clear.

In the present disclosure, it will be understood that, although the terms “first”, “second”, etc. may be used herein to describe various components, these components should not be limited by these terms. These terms are only used to distinguish one component from other components. For instance, a first component discussed below could be termed a second component without departing from the teachings of the present disclosure. Similarly, a second component could also be termed a first component. The term “and/or” includes any and all combinations of one or more of the associated listed items.

It will be understood that when a component is referred to as being “connected” or “coupled” to another component, it can be directly connected or coupled to the other component, or intervening components may be present. In contrast, it should be understood that when a component is referred to as being “directly coupled” or “directly connected” to another component, there are no intervening component present.

The components described in the embodiments are independently shown in order to indicate different characteristic functions, but this does not mean that each of the components is formed of a separate piece of hardware or software. That is, components are arranged and included separately for convenience of description. For example, at least two of the components may be integrated into a single component. Conversely, one component may be divided into multiple components. An embodiment into which the components are integrated or an embodiment in which some components are separated is included in the scope of the present specification, as long as it does not depart from the essence of the present specification.

The terms used in embodiments are merely used to describe specific embodiments and are not intended to limit the present disclosure. A singular expression includes a plural expression unless a description to the contrary is specifically pointed out in context. In the embodiments, it should be understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added. That is, it should be noted that, in embodiments, an expression describing that a component “comprises” a specific component means that additional components may be included in the scope of the practice or the technical spirit of the embodiments, but do not preclude the presence of components other than the specific component.

In embodiments, the term “at least one” means one of numbers of 1 or more, such as 1, 2, 3, and 4. In the embodiments, the term “a plurality of” means one of numbers of 2 or more, such as 2, 3, or 4.

Some components in embodiments are not essential components for performing essential functions, but may be optional components for improving only performance. The embodiments may be implemented using only essential components for implementing the essence of the embodiments. For example, a structure including only essential components, excluding optional components used only to improve performance, is also included in the scope of the embodiments.

Embodiments of the present disclosure are described with reference to the accompanying drawings in order to describe the present disclosure in detail so that those having ordinary knowledge in the technical field to which the present disclosure pertains can easily practice the present disclosure. In the following description of the present disclosure, detailed descriptions of known functions and configurations which are deemed to make the gist of the present disclosure obscure will be omitted. It should be noted that the same reference numerals are used to designate the same or similar components throughout the drawings, and that descriptions of the same components will be omitted.

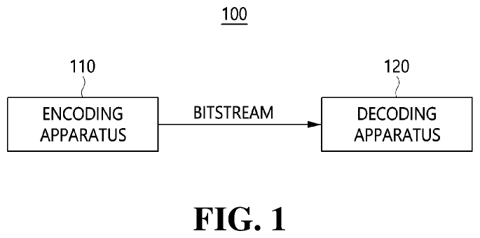

FIG. 1 illustrates an image processing system according to an embodiment.

An image processing system 100 may include an encoding apparatus 110 and a decoding apparatus 120.

The encoding apparatus 110 may generate a bitstream including information about an image.

The bitstream may be transmitted from the encoding apparatus 110 to the decoding apparatus 120.

The decoding apparatus 120 may generate a reconstructed image using the information about the image in the bitstream.

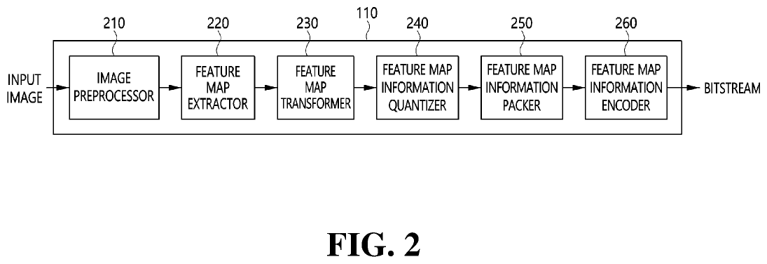

FIG. 2 is a configuration diagram of an encoding apparatus according to an embodiment.

The encoding apparatus 110 may include at least one of an image preprocessor 210, a feature map extractor 220, a feature map transformer 230, a feature map information quantizer 240, a feature map information packer 250 or a feature map information encoder 260, or a combination thereof.

An input image may be applied to the image preprocessor 210.

In embodiments, the input image may include multiple images.

The feature map information encoder 260 may output a bitstream.

The operations of the components of the encoding apparatus 110 will be described in detail below.

Referring to FIG. 2, the following processes may be performed by the encoding apparatus 110.

First, a feature map may be extracted from the input image.

Next, a transform may be performed on the extracted feature map.

Next, feature map information may be acquired from the feature map through the transform.

Next, at least one of quantization or packing, or a combination thereof may be performed on the feature map information.

Next, encoding may be performed on the feature map information to which at least one of the quantization or the packing, or a combination thereof is applied.

Next, the bitstream may be generated through encoding. The bitstream may include one or more bitstreams.

The feature map information may be classified into one or more types. According to the type of feature map information, at least one of the above-described quantization or packing, or a combination thereof may be skipped in encoding of the feature map information.

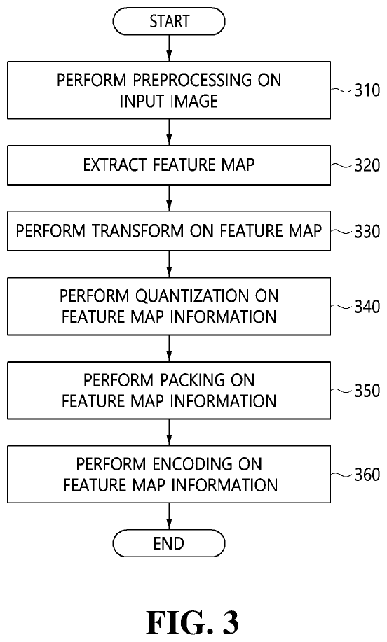

FIG. 3 is a flowchart illustrating a feature map extraction and encoding method according to an embodiment.

Steps illustrated in FIG. 3, which are independent and separate components, may be respectively implemented, or may be implemented as a single component. Further, at least some of the steps described in FIG. 3 may be skipped.

At step 310, the image preprocessor 210 may generate a preprocessed input image by performing a preprocessing procedure on an input image.

Preprocessing may include color format conversion and resolution adjustment. For example, the image preprocessor 210 may perform the preprocessing process such as color format conversion and resolution adjustment on the input image.

In embodiments, the input image may refer to the preprocessed input image to which preprocessing at step 310 is applied.

At step 320, the feature map extractor 220 may output a feature map for the input image.

The feature map extractor 220 may extract the feature map from the input image, and may output the extracted feature map.

The information described in embodiments may include multiple pieces of information. Alternatively, the information described in embodiments may be a group of information. For example, the feature map may include multiple feature maps. In embodiments, the feature map may refer to a group of feature maps. The feature map information may include multiple pieces of feature map information. The feature map information may refer to a group of feature map information. Further, in embodiments, information related to the feature map may refer to a group of information related to the feature map. In embodiments, information related to the feature map information may refer to a group of information related to the feature map information.

For example, the feature map extractor 220 may extract the feature map from the preprocessed input image.

In an embodiment, the feature map extractor 220 may be defined as a

feature pyramid network structure. Alternatively, the feature map extractor 220 may have the feature pyramid network structure. The feature pyramid network structure will be described in detail below.

At step 330, the feature map transformer 230 may acquire the feature map information from the feature map.

In an embodiment, the feature map information may include a basis vector and/or a transform coefficient.

The feature map transformer 230 may generate the feature map information by performing a transform on the feature map.

The feature map transformer 230 may derive a basis vector for the transform unit of the feature map and perform a transform on the transform unit.

The feature map transformer 230 may derive a transform coefficient by performing a transform on the feature map based on the basis vector.

In embodiments, the information generated by the feature map transformer 230 may be included in the feature map information. Alternatively, the information generated by the feature map transformer 230 may be included in the bitstream.

At step 340, the feature map information quantizer 240 may generate quantized feature map information by performing quantization on the feature map information.

Hereinafter, in embodiments, the feature map information may refer to the quantized feature map information.

Quantization may be linear quantization or nonlinear quantization.

In an embodiment, the type of quantization applied to the feature map information may be determined according to the type of feature map information. The quantization method to be applied to the feature map information may be selected from among multiple quantization methods based on the type of feature map information.

In an embodiment, different types of quantization may be performed on pieces of feature map information having different types depending on the type of feature map information.

For example, linear quantization may be performed on the first type of feature map information, and nonlinear quantization may be performed on the second type of feature map information.

For example, the first type of feature map information may be any one of

a basis vector and a transform coefficient, and the second type of feature map information may be the other thereof.

Alternatively, linear quantization or nonlinear quantization may be performed on the first type of feature map information, and quantization may not be performed on the second type of feature map information.

For example, although the linear quantization or nonlinear quantization may be equally performed on the first type of feature map information and the second type of feature map information, quantization parameters to be applied to the first type of feature map information and the second type of feature map information may be different from each other.

At step 350, the feature map information packer 250 may generate clustered feature map information by performing clustering on one or more pieces of feature map information, and may generate packed feature map information by performing arrangement on the clustered feature map information.

The feature map information packer 250 may generate a feature map group header including information related to clustering and arrangement.

The feature map group header may include information indicating the index of the feature map information, the channel size of the feature map information, and the type of a decoder used for decoding of the feature map information. For example, information indicating the type of decoder used for decoding of the feature map information may be the index of the decoder.

The feature map group header may include information indicating the index of each of one or more pieces of feature map information, the channel size of each piece of feature map information, and the type of the decoder.

By means of the feature map group header, such information may be signaled from the encoding apparatus 110 to the decoding apparatus 120.

At step 360, the feature map information encoder 260 may generate a bitstream including encoded feature map information by performing encoding on the feature map information.

For example, the feature map information input to the feature map information encoder 260 may be the quantized feature map information or the packed feature map information.

The bitstream may include the feature map group header.

The bitstream may include quantization information. The quantization information may refer to a quantization method applied to each of one or more pieces of feature map information of the bitstream. The quantization information may be included in the feature map group header.

The feature map information encoder 260 may transmit the bitstream to the decoding apparatus 120.

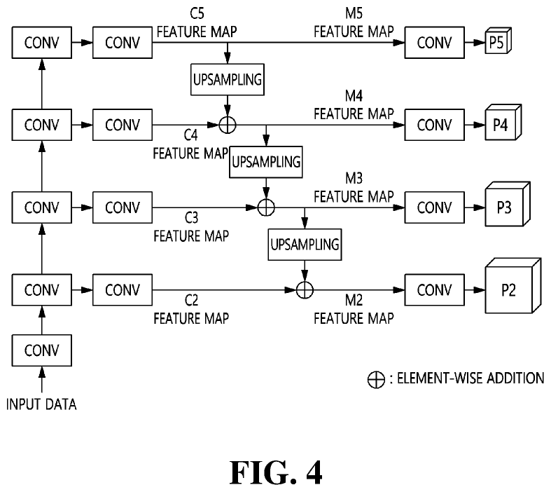

FIG. 4 illustrates the structure of a feature map extractor according to an embodiment.

The feature map extractor 220 may have a feature pyramid network structure for extracting a feature map from an image or a video.

In embodiments, the feature map may include multiple feature maps having different resolutions.

The feature map extractor 220 may extract multiple feature maps having different resolutions.

In FIG. 4, each “Cony” block may be a convolution block (or a convolution layer block) composed of one or more convolution layers.

In FIG. 4, an upper layer is illustrated in the lower portion of FIG. 4, and a lower layer is illustrated in the upper portion of FIG. 4. In other words, the upper layer may be the layer at a lower level in FIG. 4. The lower layer may be the layer at a higher level in FIG. 4.

For example, in FIG. 4, P2 may indicate a P2 feature map at the uppermost layer. P5 may indicate a P5 feature map at the lowermost layer.

A feature map used for compression may be defined by a combination of layers and levels.

For example, the layers may include a C-layer, an M-layer, a P-layer, etc. Letters C, M, and P in the layers of feature maps may denote specific layers in a pyramid structure. Numeral N next to each letter may denote the level at the pyramid structure.

For example, a P2 feature map, a P3 feature map, a P4 feature map, and a P5 feature map may be respectively extracted through convolution blocks.

On the P-layer, the importance levels of feature maps at respective levels may be determined by the size of the object to be detected. Therefore, depending on the levels of the feature maps, the importance levels of the feature maps may be different from each other. In other words, the importance levels of the feature maps may be determined based on the levels of the feature maps.

In an embodiment, during a process of extracting feature maps of each of one or more layers, an addition operation of a feature map in a certain layer and a feature map in a lower layer (or at a higher level in FIG. 4) adjacent to the certain layer may be performed in order to generate a feature map in an upper layer (or at a lower level in FIG. 4). In other words, the feature map in a lower layer, which is adjacent to a specific layer, may be added to the feature map in the specific layer.

The addition operation may be an element-wise addition operation.

In an example, upsampling on the feature map in the lower layer may be performed before the addition operation. In other words, as upsampling is applied to the feature map in the lower layer, an upsampled feature map may be generated, and the upsampled feature map in the lower layer adjacent to the specific layer may be added to the feature map in the specific layer.

Here, as an upsampling method, at least one of bicubic interpolation, bilinear interpolation, nearest neighbor interpolation, or a deep learning-based interpolation method or a combination thereof may be used.

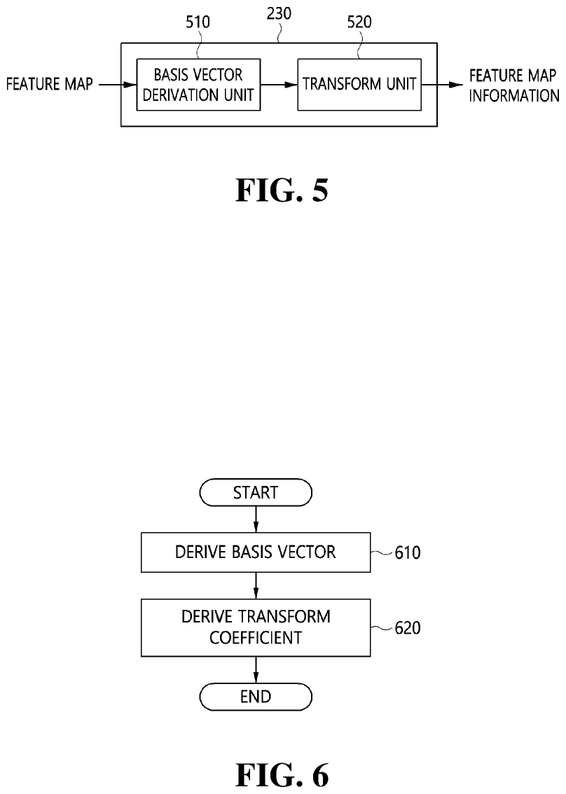

FIG. 5 is a block diagram of a feature map transformer according to an embodiment.

The feature map transformer 230 may include a basis vector derivation unit 510 and a transform unit 520.

In an embodiment, a fixed basis vector and/or a fixed transform coefficient may be used to eliminate redundancy among levels in a feature pyramid network and/or redundancy among channels and improve compression efficiency.

In an embodiment, when the fixed basis vector or the fixed transform coefficient is used, the basis vector derivation unit 510 may be omitted.

In an embodiment, the fixed basis vector may be a constant related to the basis vector. The fixed basis vector may be a constant used to derive the basis vector.

In an embodiment, the fixed transform coefficient may be a constant related to the transform coefficient. The fixed transform coefficient may be a constant used to derive the transform coefficient.

In other words, when the fixed basis vector or the fixed transform coefficient is used, the derivation of the basis vector may be skipped. When the basis vector or the transform coefficient is not fixed, the derivation of the basis vector may be required.

When the fixed basis vector or the fixed transform coefficient is used between the encoding apparatus 110 and the decoding apparatus 120, a common basis vector extraction unit 910, which will be described later, or the transform unit 520 may be used to extract the fixed basis vector or the fixed transform coefficient.

In embodiments, the information generated by the transform unit 520 may be included in the feature map information. Alternatively, the information generated by the transform unit 520 may be included in the bitstream.

FIG. 6 is a flowchart of a feature map transform method according to an embodiment.

Step 330 may include steps 610 and 620.

At step 610, the basis vector derivation unit 510 may derive the basis vector of a feature map using the feature map.

At step 620, the transform unit 520 may derive a transform coefficient by performing a transform on the feature map based on the basis vector.

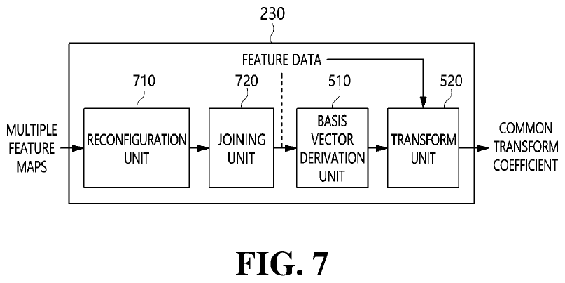

FIG. 7 is a block diagram of a feature map transformer according to an embodiment.

The feature map transformer 230 may include a reconfiguration unit 710, a joining unit 720, a basis vector derivation unit 510, and a transform unit 520.

A fixed transform coefficient may be derived from multiple images. The multiple images may be N images. Each of the multiple images may be the input image of FIG. 2. The multiple images may be images other than the input image. In this case, the fixed transform coefficient may be treated as a constant.

In order to extract the fixed transform coefficient, methods such as Principal Component Analysis (PCA) and Latent Dirichlet Allocation (LDA) may be used.

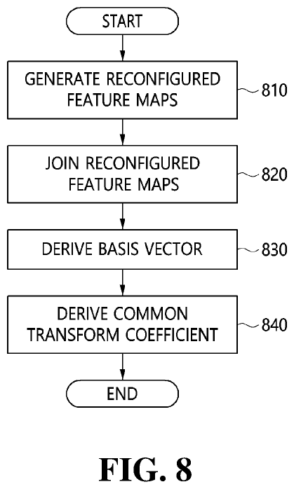

FIG. 8 is a flowchart of a feature map transform method according to an embodiment.

As described above, at step 320, one or more feature maps may be extracted from an input image.

Step 330 may include steps 810, 820, 830, and 840.

At step 810, the reconfiguration unit 710 may generate one or more reconfigured feature maps by performing reconfiguration on the one or more feature maps.

Here, the resolutions of the multiple images may be different from each other. Alternatively, multiple images having different resolutions may be selected from among the images of the input image, and the selected multiple images may be used at step 810.

Further, one or more feature maps for the multiple images may be extracted from the same layer in the above-described convolution (Cony) block.

Alternatively, the feature map of at least one of the multiple images may be extracted from a layer other than the layer from which other feature maps are extracted. In other words, one or more feature maps for the multiple images may be extracted from two or more layers.

At step 820, the joining unit 720 may join the one or more reconfigured feature maps into a single feature map. The joining unit 720 may generate a single joined feature map by joining the one or more reconfigured feature maps.

A concatenation operation may be performed for joining. The terms “join/joining”, “combine/combination”, and “concatenate/concatenation” may be used to have the same meaning and may be used interchangeably with each other.

By the reconfiguration unit 710 and the joining unit 720, feature data for deriving the fixed transform coefficient may be configured. The feature data may be a single joined feature map.

Step 830 may correspond to the above-described step 610. Here, the feature map used as the input at step 610 may be feature data.

Step 840 may correspond to the above-described step 620. Here, the feature map used as the input at step 620 may be feature data. Here, the transform coefficients of multiple images derived at step 840 may be a common transform coefficient.

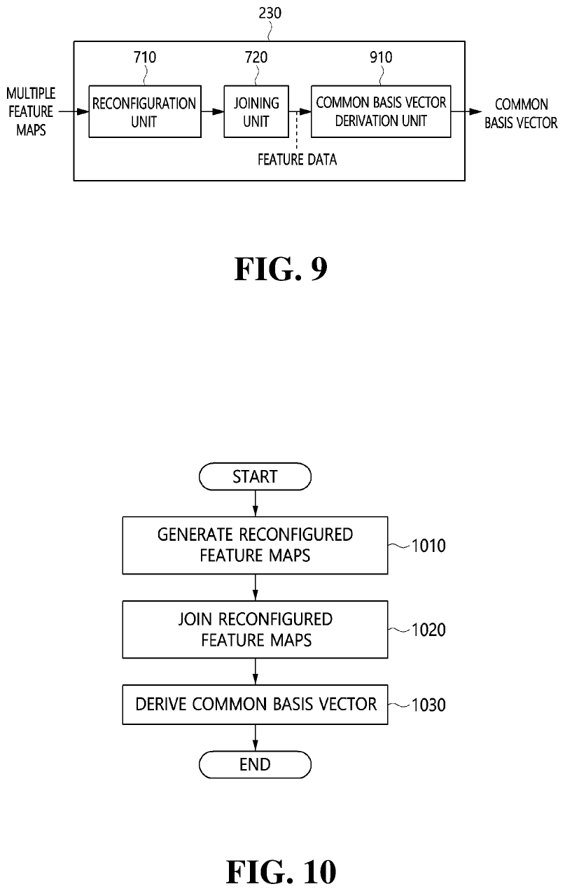

FIG. 9 is a block diagram of a feature map transformer according to an embodiment.

The feature map transformer 230 may include a reconfiguration unit 710, a joining unit 720, and a common basis vector derivation unit 910.

In an embodiment, a fixed basis vector may be derived from multiple images. The multiple images may be N images. Each of the multiple images may be the input image of FIG. 2. The multiple images may be images other than the input image. In this case, the fixed basis vector may be treated as a constant.

In order to extract the fixed basis vector, methods such as Principal Component Analysis (PCA) and Latent Dirichlet Allocation (LDA) may be used.

FIG. 10 is a flowchart of a feature map transform method according to an embodiment.

As described above, at step 320, one or more feature maps may be extracted from an input image.

Steps 330 may include steps 1010, 1020, and 1030.

At step 1010, the reconfiguration unit 710 may generate one or more reconfigured feature maps by performing reconfiguration on the one or more feature maps.

Here, the resolutions of the multiple images may be different from each other. Alternatively, multiple images having different resolutions may be selected from among the images of the input image, and the selected multiple images may be used at step 1010.

Further, one or more feature maps for the multiple images may be extracted from the same layer in the above-described convolution (Cony) block.

Alternatively, the feature map of at least one of the multiple images may be extracted from a layer other than the layer from which other feature maps are extracted. In other words, one or more feature maps for the multiple images may be extracted from two or more layers.

At step 1020, the joining unit 720 may join the one or more reconfigured feature maps into a single feature map. The joining unit 720 may generate a single joined feature map by joining the one or more reconfigured feature maps.

A concatenation operation may be performed for joining.

By means of the reconfiguration unit 710 and the joining unit 720, feature data for deriving a common basis vector may be configured. The feature data may be a single joined feature map.

At step 1030, the common basis vector derivation unit 910 may derive the common basis vector of one or more feature maps using the feature data.

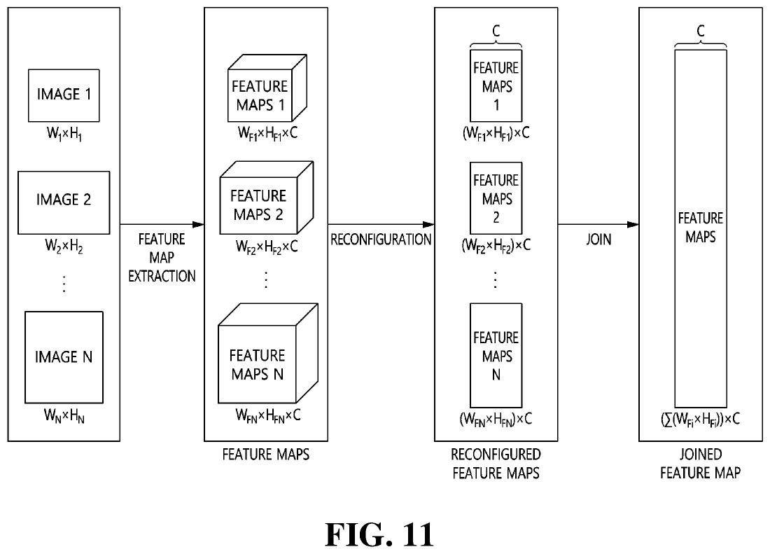

FIG. 11 illustrates a process in which a joined feature map is generated from multiple images according to an example.

In FIG. 11, image 1 to image N are depicted as multiple images.

The resolutions of image 1 to image N may be W₁×H₁ to W_{N}×H_{N}, respectively.

Feature maps corresponding to a specific level may be extracted from respective images. The dimensions of the feature maps extracted from multiple images may be W_{F1}×H_{F1}×C to W_{FN}×H_{FN}×C.

Reconfiguration of each of the extracted feature maps may be performed. Multiple reconfigured feature maps may be generated through reconfiguration of the multiple feature maps.

The dimensions of the multiple reconfigured feature maps may be (W_{F1}×H_{F1})×C to (W_{FN}×H_{FN})×C, respectively.

A joined feature map having (Σ(W_{Fi}×H_{Fi})×C dimensions may be generated by joining the multiple reconfigured feature maps. The joined feature map may be used as feature data required for deriving a fixed basis vector or a fixed transform coefficient.

In an embodiment, the feature data generated through the above-described scheme may include Σ(W_{Fi}×H_{Fi}) pieces of data. The dimension of each of the Σ(W_{Fi}×H_{Fi}) pieces of data may be 1×C. A fixed common basis vector having C×C dimensions corresponding to the Σ(W_{Fi}×H_{Fi}) pieces of data may be derived.

The relationship between the basis vector and the fixed basis vector, described above in embodiments, may also be applied to a common basis vector and the fixed common basis vector. In other words, the fixed common basis vector may be a fixed value for the common basis vector.

In an embodiment, the feature data generated through the above-described scheme may include C pieces of data. The dimension of each of the C pieces of data may be 1×Σ(W_{Fi}×H_{Fi}). The basis vector having Σ(W_{Fi}×H_{Fi})×C dimensions corresponding to the C pieces of data may be derived.

A fixed common transform coefficient having C×C dimensions may be derived by performing a transform based on at least one of the derived basis vector, the feature data, or a combination thereof.

The relationship between the transform coefficient and the fixed transform coefficient, described above in embodiments, may be applied to a common transform coefficient and the fixed common transform coefficient. In other words, the fixed common transform coefficient may be a fixed value for the common transform coefficient.

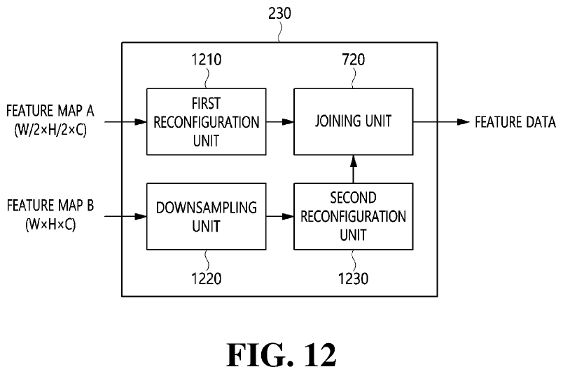

FIG. 12 is a block diagram of a feature map transformer for generating feature data according to an embodiment.

A feature map transformer 230 may include a first reconfiguration unit 1210, a downsampling unit 1220, a second reconfiguration unit 1230, and a joining unit 720.

The first reconfiguration unit 1210 and the second reconfiguration unit 1230 may correspond to the reconfiguration unit 710. Alternatively, the first reconfiguration unit 1210 and the second reconfiguration unit 1230 may be different components.

Feature map A may be input to the first reconfiguration unit 1210.

Feature map B may be applied to the downsampling unit 1220.

The joining unit 720 may output feature data.

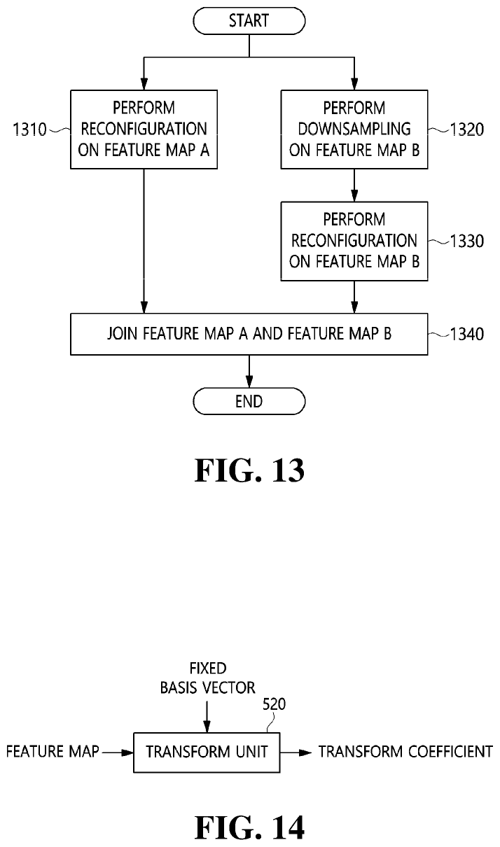

FIG. 13 illustrates a feature data generation method for deriving a fixed basis vector or a fixed transform coefficient according to an embodiment.

In an embodiment, multiple feature maps having different levels may be extracted from a single image. For example, feature maps may be extracted from P-layer illustrated in FIG. 4.

Here, feature data may be generated by independently applying the feature map transform methods, described with reference to FIGS. 8 and 10, to feature maps at respective levels extracted from the multiple image.

A fixed common basis vector and/or a fixed common transform coefficient may be derived based on the generated feature data.

In an embodiment, when multiple feature maps having different resolutions or different levels are extracted from one image, feature data may be generated from the feature map extracted through the above-described reconfiguration and joining process. Similarly, a fixed common basis vector and/or a fixed common transform coefficient may be derived based on the generated feature data.

Here, upsampling or downsampling on a specific feature map among the multiple feature maps having different resolutions may be performed such that the resolution of the specific feature map becomes identical to that of other feature maps.

After such upsampling or downsampling is applied to the feature map, reconfiguration for the feature map may also be performed. On the contrary, after reconfiguration is performed on the feature map, upsampling or downsampling may also be applied to the reconfigured feature map. In an embodiment, in order to generate the feature data, step 330 may include steps 1310, 1320, 1330, and 1340.

For example, the multiple feature maps may include feature map A and feature map B.

At step 1310, the first reconfiguration unit 1210 may generate reconfigured feature map A by performing reconfiguration on feature map A.

For example, the resolution of feature map A may be W/2×H/2×C.

At step 1320, the downsampling unit 1220 may generate downsampled feature map B by performing downsampling on feature map B.

For example, the resolution of feature map B may be W×H×C.

For example, the resolution of the downsampled feature map B may be W/2×H/2×C. Feature map B may be downsampled by the downsampling unit 1220 so that the resolution of feature map B becomes identical to that of feature map A.

At step 1330, the second reconfiguration unit 1230 may generate reconfigured downsampled feature map B by performing reconfiguration on the downsampled feature map B.

At step 1340, the joining unit 720 may join the reconfigured feature map A and the reconfigured downsampled feature map B into a single feature map. The joining unit 720 may generate a single joined feature map by joining the reconfigured feature map A and the reconfigured downsampled feature map B. The feature data may be the single joined feature map.

At least one of the basis vector, the common basis vector, the transform coefficient or the common transform coefficient, which is extracted from the image through the above-described methods, or a combination thereof may be fixed by an agreement between the encoding apparatus 110 and the decoding apparatus 120. In other words, at least one of the basis vector, the common basis vector, the transform coefficient, or the common transform coefficient, or a combination thereof may be shared between the encoding apparatus 110 and the decoding apparatus 120.

Here, the basis vector and the transform coefficient may refer to a basis vector and a transform coefficient, respectively, which are applied to a specific image. The common basis vector and the common transform coefficient may refer to a basis vector and a transform coefficient, respectively, which are applied in common to multiple images.

FIG. 14 illustrates the operation of a transform unit according to an embodiment.

When a fixed basis vector is used in the feature map transformer 230, the feature map transformer 230 may be operated, as shown in FIG. 14.

A feature map and the fixed basis vector may be input to the transform unit 520. The transform unit 520 may output a transform coefficient.

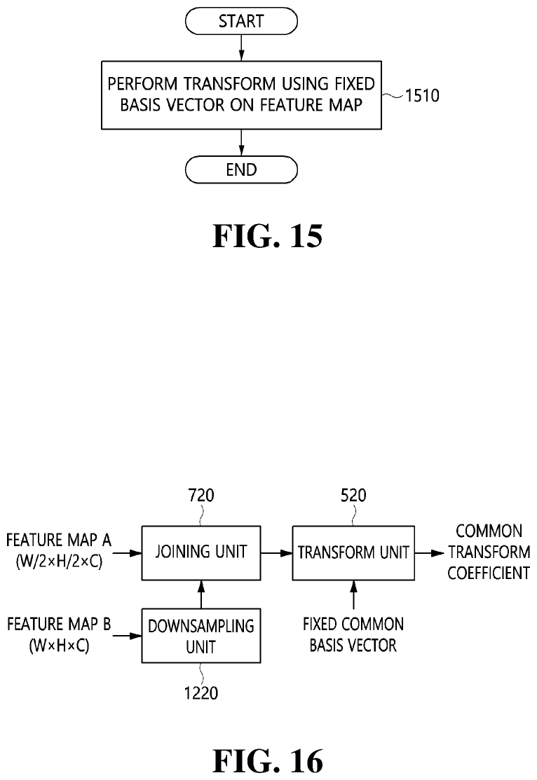

FIG. 15 illustrates a feature map transform process using a fixed basis vector according to an embodiment.

Step 330 may include step 1510.

At step 1510, the transform unit 520 may perform a transform using a fixed basis vector on a feature map.

The transform unit 520 may generate a transform coefficient by performing the transform using the fixed basis vector on the feature map.

The transform coefficient extracted through the transform may be feature map information, and may be used as the input of the feature map information quantizer 240.

FIG. 16 illustrates the operation of a transform unit according to an embodiment.

When a fixed common basis vector is used in the feature map transformer 230, the feature map transformer 230 may be operated, as shown in FIG. 16.

Feature map A may be input to the joining unit 720.

Feature map B may be input to the downsampling unit 1220. The downsampling unit 1220 may generate downsampled feature map B. The downsampled feature map B may be input to the joining unit 720.

The joining unit 720 may generate a joined feature map.

The joined feature map and the fixed common basis vector may be input to the transform unit 520. The transform unit 520 may output a common transform coefficient.

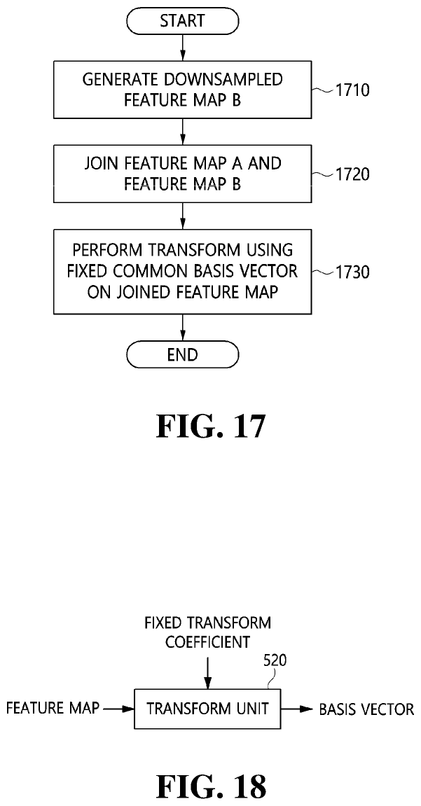

FIG. 17 illustrates a feature map transform process using a fixed common basis vector according to an embodiment.

Referring to FIG. 17, the same joining as joining used to derive the above-described fixed common basis vector may be performed on multiple feature maps. A transform using the fixed common basis vector may be performed on the multiple joined feature maps.

Steps 330 may include steps 1710, 1720, and 1730.

At step 1710, the downsampling unit 1220 may generate downsampled feature map B by performing downsampling on feature map B.

For example, the resolution of feature map B may be W×H×C.

For example, the resolution of the downsampled feature map B may be W/2×H/2×C. Feature map B may be downsampled by the downsampling unit 1220 so that the resolution of feature map B becomes identical to that of feature map A.

At step 1720, the joining unit 720 may join feature map A and the downsampled feature map B into a single feature map. The joining unit 720 may generate a joined feature map by joining feature map A and the downsampled feature map B.

For example, the resolution of feature map A may be W/2×H/2×C.

At step 1730, the transform unit 520 may perform a transform using a fixed common basis vector on the joined feature map.

The transform unit 520 may generate a common transform coefficient by performing the transform using the fixed common basis vector on the joined feature map.

The common transform coefficient extracted through the transform may be feature map information, and may be used as the input of the feature map information quantizer 240.

FIG. 18 illustrates the operation of a transform unit according to an embodiment.

When a fixed transform coefficient is used in the feature map transformer 230, the feature map transformer 230 may be operated, as shown in FIG. 18.

A feature map and the fixed transform coefficient may be input to the transform unit 520. The transform unit 520 may output a basis vector.

When the fixed transform coefficient is used in the feature map transformer 230, the feature map transformer 230 may be operated, as shown in the block diagram of FIG. 18.

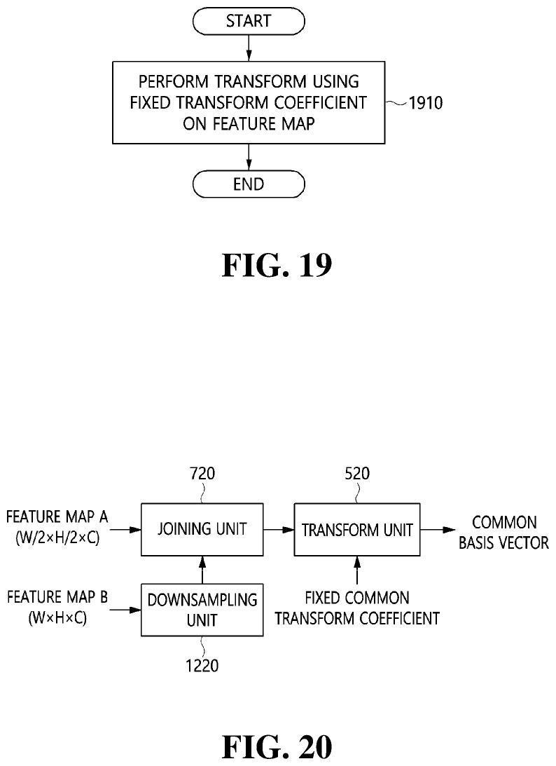

FIG. 19 illustrates a feature map transform process using a fixed transform coefficient according to an embodiment.

Step 330 may include step 1910.

At step 1910, the transform unit 520 may perform a transform using a fixed transform coefficient on a feature map.

The transform unit 520 may generate a basis vector by performing the transform using the fixed transform coefficient on the feature map.

The basis vector extracted through the transform may be feature map information, and may be used as the input of the feature map information quantizer 240.

FIG. 20 illustrates the operation of a transform unit according to an embodiment.

When a fixed common transform coefficient is used in the feature map transformer 230, the feature map transformer 230 may be operated, as shown in FIG. 20.

Feature map A may be input to the joining unit 720.

Feature map B may be input to the downsampling unit 1220. The downsampling unit 1220 may generate downsampled feature map B. The downsampled feature map B may be input to the joining unit 720.

The joining unit 720 may generate a joined feature map.

The joined feature map and the fixed common transform coefficient may be input to the transform unit 520. The transform unit 520 may output a common basis vector.

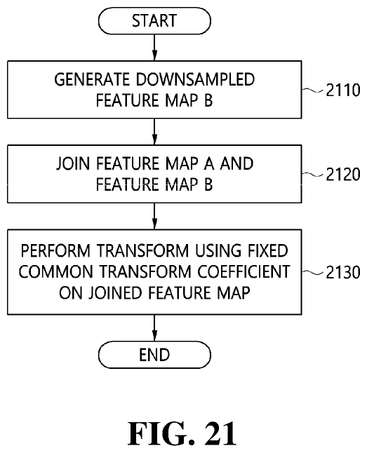

FIG. 21 illustrates a feature map transform process using a fixed common transform coefficient according to an embodiment.

Referring to FIG. 21, the same joining as joining used to derive the above-described fixed common transform coefficient may be performed on multiple feature maps. A transform using the fixed common transform coefficient may be performed on multiple feature maps that are joined.

Steps 330 may include steps 2110, 2120, and 2130.

At step 2110, the downsampling unit 1220 may generate downsampled feature map B by performing downsampling on feature map B.

For example, the resolution of feature map B may be W×H×C.

For example, the resolution of the downsampled feature map B may be W/2×H/2×C. Feature map B may be downsampled by the downsampling unit 1220 so that the resolution of feature map B becomes identical to that of feature map A.

At step 2120, the joining unit 720 may join feature map A and downsampled feature map B into a single feature map. The joining unit 720 may generate a joined feature map by joining feature map A and the downsampled feature map B.

For example, the resolution of feature map A may be W/2×H/2×C.

At step 2130, the transform unit 520 may perform a transform using the fixed common transform coefficient on the joined feature map.

The transform unit 520 may generate a common basis vector by performing the transform using the fixed common transform coefficient on the joined feature map.

The common basis vector extracted through the transform may be feature map information, and may be used as the input of the feature map information quantizer 240.

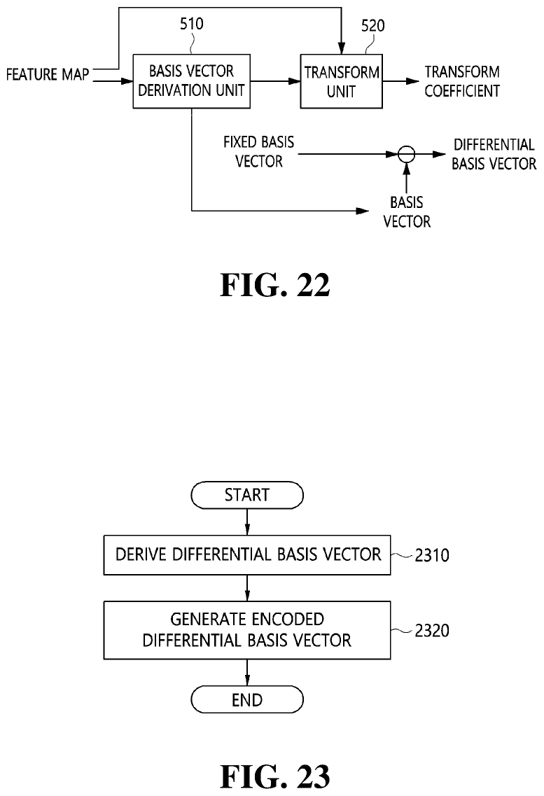

FIG. 22 illustrates a process of encoding a basis vector according to an embodiment.

A transform coefficient and a basis vector, which are output from the feature map transformer 230, may be individually encoded.

Before encoding is performed, at least one of the above-described quantization or packing, or a combination thereof may be performed on at least one of the transform coefficient or the basis vector, output form the feature map transformer 230, or a combination thereof. In other words, the feature map information input to the feature map information encoder 260 may be quantized feature map information or packed feature map information.

Of the transform coefficient and the basis vector output from the feature map transformer 230, the basis vector may be encoded based on differential encoding that uses a fixed basis vector agreed upon to be the same between the encoding apparatus 110 and the decoding apparatus 120.

That is, a differential basis vector that is the difference between the basis vector extracted from the feature map transformer 230 and the fixed basis vector may be encoded.

FIG. 23 is a flowchart illustrating a method for encoding a basis vector according to an embodiment.

The basis vector derivation unit 510 may derive a basis vector from a feature map.

In an embodiment, step 360 may include step 2310.

At step 2310, the feature map information encoder 260 may derive a differential signal (i.e., a differential basis vector) between the basis vector and the fixed basis vector.

Alternatively, step 1030 may include step 2310. In this case, at step 2310, the basis vector derivation unit 510 may derive a differential signal (i.e., a differential basis vector) between the basis vector and the fixed basis vector.

Here, the transform unit 520 may generate a transform coefficient by performing a transform using at least one of the basis vector derived by the basis vector derivation unit 510, the feature map, or a combination thereof, and may output the generated transform coefficient.

At least one of quantization, packing or encoding, or a combination thereof may be performed on the output transform coefficient and the differential signal. Quantization and packing may be selectively performed on the transform coefficient and the differential signal.

In an embodiment, the fixed basis vector may be information equally fixed (or information equally defined) in the encoding apparatus 110 and the decoding apparatus 120.

Alternatively, in an embodiment, the fixed basis vector may be derived by the methods described with reference to FIGS. 7 to 11.

Step 360 may include step 2320.

At step 2320, the feature map information encoder 260 may generate an encoded differential signal (e.g., an encoded differential basis vector) by performing encoding on the differential signal.

The feature map information encoder 260 may generate a bitstream including the encoded differential signal (e.g., an encoded differential basis vector) by performing encoding on the differential signal.

When the bitstream including the encoded differential signal is transmitted to the decoding apparatus 120, the decoding apparatus 120 may acquire a (reconstructed) differential signal (i.e., a (reconstructed) differential basis vector) by performing reconstruction (or decoding) on the encoded differential signal.

The decoding apparatus 120 may reconstruct the basis vector based on the (reconstructed) differential signal and the fixed basis vector. Here, the fixed basis vector may be pre-agreed upon (or predefined) by the decoding apparatus 120.

During a process of reconstructing the differential signal, the decoding apparatus 120 may further perform at least one of inverse-packing or inverse quantization (dequantization), or a combination thereof on the (reconstructed) differential signal. The decoding apparatus 120 may reconstruct the feature map by performing an inverse transform that uses the (reconstructed) basis vector.

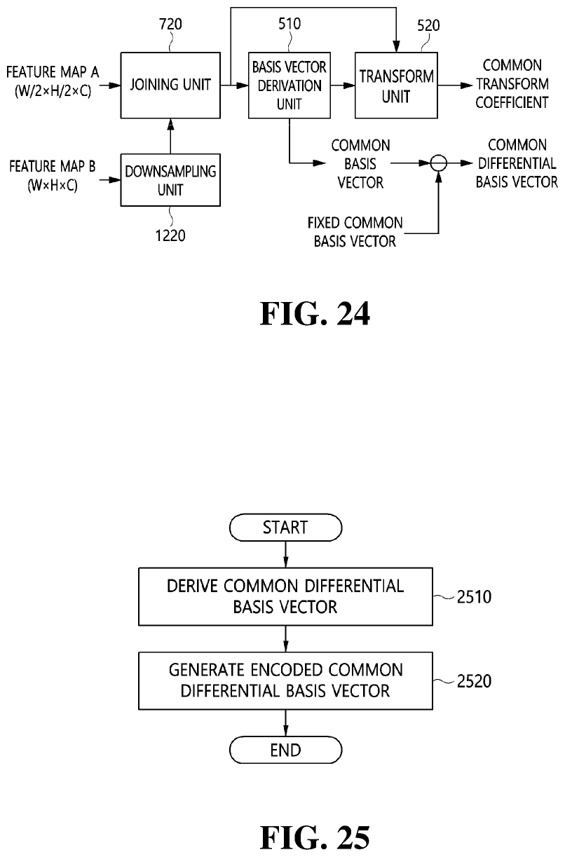

FIG. 24 illustrates a process for encoding a common basis vector according to an embodiment.

A transform coefficient and a basis vector, which are output from the feature map transformer 230, may be individually encoded.

Before encoding is performed, at least one of the above-described quantization or packing, or a combination thereof may be performed on at least one of the transform coefficient or the basis vector, output form the feature map transformer 230, or a combination thereof. In other words, the feature map information input to the feature map information encoder 260 may be quantized feature map information or packed feature map information.

Of the transform coefficient and the basis vector output from the feature map transformer 230, the basis vector may be encoded based on differential encoding that uses a fixed common basis vector agreed upon to be the same between the encoding apparatus 110 and the decoding apparatus 120.

That is, a common differential basis vector that is the difference between the common basis vector extracted by the feature map transformer 230 and the fixed common basis vector may be encoded.

FIG. 25 is a flowchart illustrating a method for encoding a common basis vector according to an embodiment.

The basis vector derivation unit 510 may derive a common basis vector from multiple feature maps.

In an embodiment, the multiple feature maps may refer to multiple feature maps having different levels (or different resolutions) extracted from one image.

Alternatively, in an embodiment, multiple feature maps may refer to feature maps respectively extracted from different layers.

In an embodiment, step 360 may include step 2510.

At step 2510, the feature map information encoder 260 may derive a differential signal (i.e., a common differential basis vector) between the common basis vector and the fixed common basis vector. Here, the fixed common basis vector may be pre-agreed upon (or predefined) by the encoding apparatus 110.

Alternatively, step 1030 may include step 2510. In this case, at step 2510, the basis vector derivation unit 510 may derive a differential signal (i.e., a common differential basis vector) between the common basis vector and the fixed common basis vector.

Here, the transform unit 520 may generate a common transform coefficient by performing a transform that uses at least one of the common basis vector derived from the basis vector derivation unit 510, or the feature map (or feature data), or a combination thereof, and may output the generated common transform coefficient.

At least one of quantization, packing or encoding, or a combination thereof may be performed on the output common transform coefficient and the differential signal. Quantization and packing may be selectively performed on the common transform coefficient and the differential signal.

In an embodiment, the fixed common basis vector may be information equally fixed (or information equally defined) in the encoding apparatus 110 and the decoding apparatus 120.

Alternatively, in an embodiment, the fixed common basis vector may be derived by the methods described with reference to FIGS. 12 and 13.

Step 360 may include step 2520.

At step 2520, the feature map information encoder 260 may generate an encoded differential signal (e.g., an encoded common differential basis vector) by performing encoding on the differential signal.

The feature map information encoder 260 may generate a bitstream including the encoded differential signal (e.g., an encoded common differential basis vector) by performing encoding on the differential signal.

When the bitstream including the encoded differential signal is transmitted to the decoding apparatus 120, the decoding apparatus 120 may acquire a (reconstructed) differential signal (i.e., (reconstructed) common differential basis vector) by performing reconstruction (or decoding) on the encoded differential signal.

The decoding apparatus 120 may reconstruct the common basis vector based on the differential signal and the fixed common basis vector. Here, the fixed common basis vector may be pre-agreed upon (or predefined) by the decoding apparatus 120.

During a process of reconstructing the differential signal, the decoding apparatus 120 may further perform at least one of inverse-packing or dequantization, or a combination thereof on the (reconstructed) differential signal. The decoding apparatus 120 may reconstruct the feature map by performing an inverse transform that uses the (reconstructed) common basis vector.

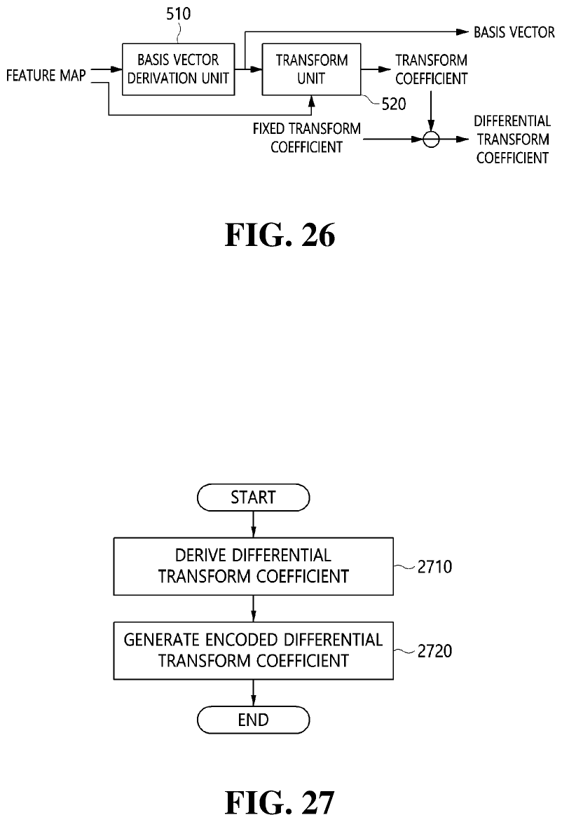

FIG. 26 illustrates a process of encoding a transform coefficient according to an embodiment.

A transform coefficient and a basis vector, which are output from the feature map transformer 230, may be individually encoded.

Before encoding is performed, at least one of the above-described quantization or packing, or a combination thereof may be performed on at least one of the transform coefficient or the basis vector, output form the feature map transformer 230, or a combination thereof. In other words, the feature map information input to the feature map information encoder 260 may be quantized feature map information or packed feature map information.

Of the transform coefficient and the basis vector output from the feature map transformer 230, the transform coefficient may be encoded based on differential encoding that uses a fixed transform coefficient vector agreed upon to be the same between the encoding apparatus 110 and the decoding apparatus 120.

That is, a differential transform coefficient that is the difference between the transform coefficient extracted from the feature map transformer 230 and the fixed transform coefficient may be encoded.

FIG. 27 is a flowchart illustrating a method for encoding a transform coefficient according to an embodiment.

The basis vector derivation unit 510 may derive a basis vector from a feature map.

In an embodiment, step 620 may include step 2710.

At step 2710, the transform unit 520 may generate a transform coefficient using at least one of the feature map or the basis vector or a combination thereof, and may output the generated transform coefficient.

Further, the transform unit 520 may derive a differential signal (that is, the differential transform coefficient) between the transform coefficient and the fixed transform coefficient. Here, the fixed transform coefficient may be pre-agreed upon (or predefined) by the encoding apparatus 110.

At least one of quantization, packing or encoding, or a combination thereof

may be performed on the output basis vector and the differential signal. Quantization and packing may be selectively performed on the basis vector and the differential signal.

In an embodiment, the fixed transform coefficient may be information equally fixed (or information equally defined) in the encoding apparatus 110 and the decoding apparatus 120.

Alternatively, in an embodiment, the fixed transform coefficient may be derived by the methods, described above with reference to FIGS. 7 to 11.

Step 360 may include step 2720.

At step 2720, the feature map information encoder 260 may generate an encoded differential signal (i.e., the encoded differential transform coefficient) by performing encoding on the differential signal.

The feature map information encoder 260 may generate a bitstream including the encoded differential signal (e.g., the encoded differential transform coefficient) by performing encoding on the differential signal.

When the bitstream including the encoded differential signal is transmitted to the decoding apparatus 120, the decoding apparatus 120 may acquire a (reconstructed) differential signal (i.e., (reconstructed) differential transform coefficient) by performing reconstruction (or decoding) on the encoded differential signal.

The decoding apparatus 120 may reconstruct a transform coefficient based on the differential signal and the fixed transform coefficient. Here, the fixed transform coefficient may be pre-agreed upon (or predefined) by the decoding apparatus 120.

The decoding apparatus 120 may generate a (reconstructed) feature map by performing an inverse transform that uses the (reconstructed) transform coefficient.

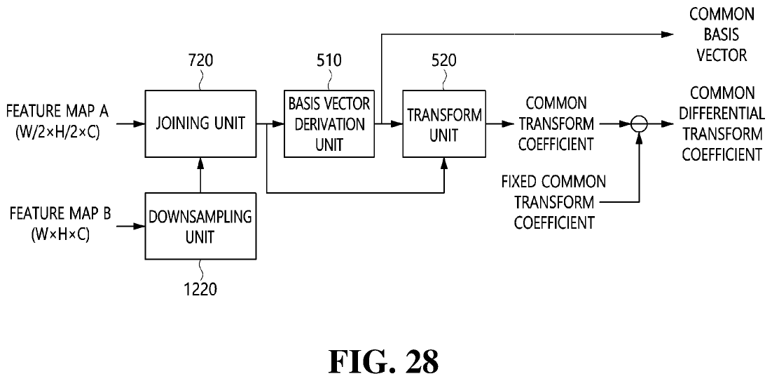

FIG. 28 illustrates a process of encoding a common transform coefficient according to an embodiment.

A transform coefficient and a basis vector, which are output from the feature map transformer 230, may be individually encoded.

Before encoding is performed, at least one of the above-described quantization or packing, or a combination thereof may be performed on at least one of the transform coefficient or the basis vector, output form the feature map transformer 230, or a combination thereof. In other words, the feature map information input to the feature map information encoder 260 may be quantized feature map information or packed feature map information.

Of the transform coefficient and the basis vector output from the feature map transformer 230, the transform coefficient may be encoded based on differential encoding that uses a fixed common transform coefficient agreed upon to be the same between the encoding apparatus 110 and the decoding apparatus 120.

That is, a common differential transform coefficient that is the difference between the common transform coefficient extracted from the feature map transformer 230 and the fixed common transform coefficient may be encoded.

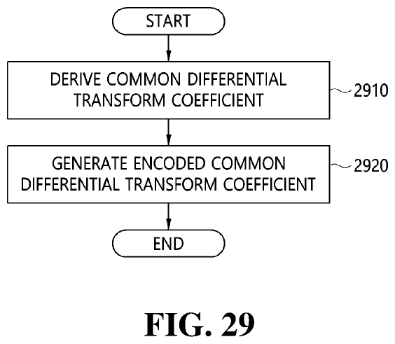

FIG. 29 is a flowchart illustrating a method for encoding a common transform coefficient according to an embodiment.

The basis vector derivation unit 510 may derive a common basis vector from multiple feature maps.

In an embodiment, the multiple feature maps may refer to multiple feature maps having different levels (or different resolutions) extracted from one image.

Alternatively, in an embodiment, multiple feature maps may refer to feature maps respectively extracted from different layers.

In an embodiment, step 620 may include step 2910.

At step 2910, the transform unit 520 may generate a common transform coefficient using at least one of the feature map (or feature data) or the common basis vector, or a combination thereof and may output the generated common transform coefficient.

Further, the transform unit 520 may derive a differential signal (i.e., the common differential transform coefficient) between the common transform coefficient and the fixed common transform coefficient. Here, the fixed common transform coefficient may be pre-agreed upon (or predefined) by the encoding apparatus 110.

At least one of quantization, packing or encoding, or a combination thereof may be performed on the output common transform coefficient and the differential signal. Quantization and packing may be selectively performed on the common transform coefficient and the differential signal.

In an embodiment, the fixed common transform coefficient may be information equally fixed (or information equally defined) in the encoding apparatus 110 and the decoding apparatus 120.

Alternatively, in an embodiment, the fixed common transform coefficient may be derived by the methods, described above with reference to FIGS. 12 and 13.

Step 360 may include step 2920.

At step 2920, the feature map information encoder 260 may generate an encoded differential signal (i.e., the encoded common differential transform coefficient) by performing encoding on the differential signal.

The feature map information encoder 260 may generate a bitstream including the encoded differential signal (e.g., the encoded common differential transform coefficient) by performing encoding on the differential signal.

When the bitstream including the encoded differential signal is transmitted to the decoding apparatus 120, the decoding apparatus 120 may acquire a (reconstructed) differential signal (i.e., (reconstructed) common differential transform coefficient) by performing reconstruction (or decoding) on the encoded differential signal.

The decoding apparatus 120 may reconstruct a transform coefficient based on the differential signal and the fixed common transform coefficient. Here, the fixed common transform coefficient may be pre-agreed upon (or predefined) by the decoding apparatus 120.

The decoding apparatus 120 may generate a (reconstructed) feature map by performing an inverse transform that uses the (reconstructed) common transform coefficient.

Both a first scheme using the fixed basis vector, described above with reference to FIGS. 14 to 17, and a second scheme using the differential basis vector, described above with reference to FIGS. 22 to 25, may be defined by the encoding apparatus 110 and the decoding apparatus 120. Alternatively, only one of the first scheme and the second scheme may be defined by the encoding apparatus 110 and the decoding apparatus 120.

Alternatively, the encoding apparatus 110 may select an optimal specific scheme between the first scheme and the second scheme, and may insert information indicating the specific scheme into a bitstream. Here, the information indicating the specific scheme may be encoded. The decoding apparatus 120 may select a specific scheme corresponding to one of the first scheme and the second scheme using the (encoded) information that indicates the specific scheme and that is inserted into the bitstream, and may reconstruct a feature map based on the selected scheme.

Both a third scheme using the fixed transform coefficient, described above with reference to FIGS. 18 to 21, and a fourth scheme using the differential transform coefficient, described above with reference to FIGS. 26 to 29, may be defined by the encoding apparatus 110 and the decoding apparatus 120. Alternatively, only one of the third scheme and the fourth scheme may be defined by the encoding apparatus 110 and the decoding apparatus 120.

Alternatively, the encoding apparatus 110 may select an optimal specific scheme between the third scheme and the fourth scheme, and may insert information indicating the specific scheme into a bitstream. Here, the information indicating the specific scheme may be encoded. The decoding apparatus 120 may select a specific scheme corresponding to one of the third scheme and the fourth scheme using the (encoded) information that indicates the specific scheme and that is inserted into the bitstream, and may reconstruct a feature map based on the selected scheme.

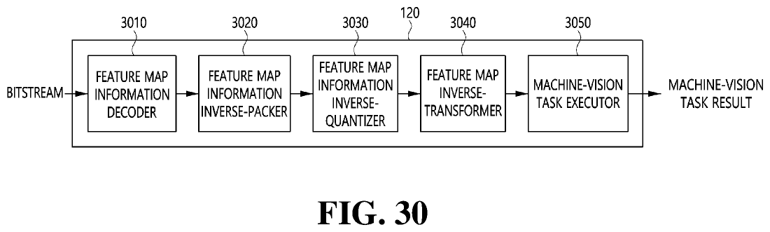

FIG. 30 is a configuration diagram of a decoding apparatus according to an embodiment.

The decoding apparatus 120 may include at least one of a feature map information decoder 3010, a feature map information inverse-packer 3020, a feature map information inverse-quantizer (dequantizer) 3030, a feature map inverse-transformer 3040 or a machine-vision task executor 3050, or a combination thereof.

A bitstream may be input to the feature map information decoder 3010.

In embodiments, the bitstream may include multiple bitstreams.

The machine vision task executor 3050 may output the result of executing a machine vision task.

Referring to FIG. 30, the following processes may be performed by the decoding apparatus 120.

First, feature map information may be acquired by performing decoding on the bitstream. The bitstream may include one or more bitstreams. The feature map information may include one or more pieces of feature map information.

The feature map information may be acquired by performing at least one of decoding, inverse packing or inverse quantization, or a combination thereof on the bitstream.

The feature map information may include information described as being generated by the feature map transformer 230, the basis vector derivation unit 510, and the transform unit 520. Alternatively, the information described as being generated by the feature map transformer 230, the basis vector derivation unit 510, and the transform unit 520 may also be included in the bitstream.

A (reconstructed) feature map may be generated by performing an inverse transform based on the acquired feature map information. A machine-vision task may be executed on the (reconstructed) feature map, and the result of the machine-vision task may be output.

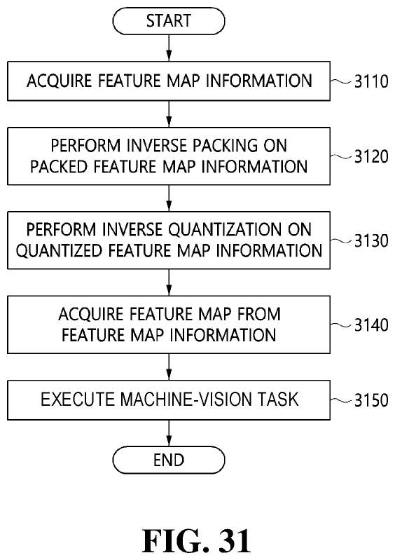

FIG. 31 is a flowchart illustrating a feature map decoding and machine vision task execution method according to an embodiment.

Steps illustrated in FIG. 31, which are independent and separate components, may be respectively implemented, or may be implemented as a single component. Further, at least some of the steps described in FIG. 31 may be skipped.

At step 3110, the feature map information decoder 3010 may receive a bitstream from the encoding apparatus 110.

The bitstream may include encoded feature map information.

In embodiments, the feature map may include multiple feature maps. In embodiments, the feature map may refer to a group of feature maps. The feature map information may refer to a group of feature map information. Further, in embodiments, information related to the feature map may refer to a group of information related to the feature map. In embodiments, information related to the feature map information may refer to a group of information related to the feature map information.

The bitstream may include the feature map group header.

The feature map group header may include information indicating the index of the feature map information, the channel size of the feature map information, and the type of a decoder used for decoding of the feature map information. For example, information indicating the type of decoder used for decoding of the feature map information may be the index of the decoder.

The bitstream may include a quantization header. Quantization information may be included in a feature map group header.

The feature map information decoder 3010 may acquire (reconstructed) feature map information from the bitstream.

The feature map information decoder 3010 may generate (reconstructed) feature map information by performing decoding on the encoded feature map information.

For example, the (reconstructed) feature map information generated by the feature map information decoder 3010 may be (reconstructed) quantized feature map information or (reconstructed) packed feature map information.

The feature map information may include one or more pieces of feature map information. The feature map information decoder 3010 may output the one or more pieces of feature map information.

In the feature map information decoder 3010, the number of decoders which perform decoding on the encoded feature map information may be one or more.

The feature map information decoder 3010 may extract information, indicating the type of a decoder used for decoding of the encoded feature map information, from the feature map group header of the bitstream, and may perform decoding on the encoded feature map information using the decoder indicated by the extracted information.

The information indicating the type of the decoder used for decoding of the encoded feature map information may be the index of the decoder.

The feature map information decoder 3010 may extract information, indicating the type of a decoder of each of the one or more pieces of encoded feature map information, from the feature map group header of the bitstream, and may perform decoding on the encoded feature map information corresponding to the extracted information using the extracted information.

When (reconstructed) packed feature map information is generated through decoding, the feature map information inverse-packer 3020 may generate one or more pieces of (reconstructed) feature map information or one or more pieces of (reconstructed) quantized feature map information by performing inverse packing on the (reconstructed) packed feature map information at step 3120.

The feature map information inverse-packer 3020 may generate (reconstructed) clustered feature map information by performing inverse arrangement on the (reconstructed) packed feature map information. Here, inverse arrangement may be inverse processing of arrangement at step 350.

The feature map information inverse-packer 3020 may separate the reconstructed (clustered) feature map information into one or more pieces of (reconstructed) feature map information by performing inverse clustering on the reconstructed (clustered) feature map information. In other words, the feature map information inverse-packer 3020 may generate one or more pieces of (reconstructed) feature map information or one or more pieces of (reconstructed) quantized feature map information by performing inverse clustering on the reconstructed (clustered) feature map information.

When (reconstructed) quantized feature map information is generated through decoding, the feature map information inverse-quantizer 3030 may generate (reconstructed) feature map information by performing inverse quantization on the (reconstructed) quantized feature map information at step 3130.

Inverse quantization may be linear inverse quantization or nonlinear inverse quantization.

In an embodiment, the type of inverse quantization applied to the (reconstructed) quantized feature map information may be determined according to the type of (reconstructed) feature map information. The inverse quantization method to be applied to the (reconstructed) quantized feature map information may be selected from among multiple inverse quantization methods based on the type of (reconstructed) feature map information.

In an embodiment, different types of quantization may be respectively performed on pieces of (reconstructed) quantized feature map information having different types depending on the type of feature map information.

For example, linear quantization may be performed on the first type of (reconstructed) quantized feature map information, and nonlinear quantization may be performed on the second type of (reconstructed) quantized feature map information.

For example, the first type of (reconstructed) quantized feature map information may be any one of a basis vector and a transform coefficient, and the second type of (reconstructed) quantized feature map information may be the other thereof.

Alternatively, linear inverse quantization or nonlinear inverse quantization may be performed on the first type of (reconstructed) quantized feature map information, and inverse quantization may not be performed on the second type of feature map information (to which quantization is not applied in the encoding process).

For example, although linear inverse quantization or nonlinear inverse quantization may be equally performed on the first type of (reconstructed) quantized feature map information and the second type of (reconstructed) quantized feature map information, inverse quantization parameters to be applied to the first type of (reconstructed) quantized feature map information and the second type of (reconstructed) quantized feature map information may be different from each other.

The bitstream may include quantization information. The quantization information may refer to a quantization method applied to each of one or more pieces of feature map information.

The feature map information inverse-quantizer 3030 may generate (reconstructed) feature map information by applying an inverse quantization method, corresponding to the quantization method applied to the feature map information using the quantization information acquired from the bitstream during an encoding process, to each of one or more pieces of (reconstructed) feature map information.

The (reconstructed) feature map information may include a (reconstructed) basis vector and/or a (reconstructed) transform coefficient.

At step 3140, the feature map inverse-transformer 3040 may acquire a (reconstructed) feature map from the (reconstructed) feature map information.

The feature map inverse-transformer 3040 may generate a (reconstructed) feature map by performing an inverse transform that uses at least one of a (reconstructed) basis vector, a (reconstructed) transform coefficient, a fixed basis vector or a fixed transform coefficient, or a combination thereof. One or more feature maps may be reconstructed through the inverse transform.

For example, the feature map inverse-transformer 3040 may generate a (reconstructed) feature map by performing an inverse transform on the (reconstructed) transform coefficient based on the (reconstructed) basis vector.

At step 3150, the machine-vision task executor 3050 may derive the result of a deep-learning network by executing a machine-vision task that is the feature map analysis process of the deep-learning network using one or more (reconstructed) feature maps.

Based on the principle of encoding and decoding, the components of the encoding apparatus 110 and the components of the decoding apparatus 120 may correspond to each other.

In an embodiment, the feature map inverse-transformer 3040 may perform the inverse operation of the operation performed by the feature map transformer 230. The information generated by the feature map transformer 230 may be information input to the feature map inverse-transformer 3040. The information input to the feature map transformer 230 may be information generated by the feature map inverse-transformer 3040. The information used for the operation of the feature map transformer 230 may also be used for the inverse operation in the feature map inverse-transformer 3040.

In an embodiment, the feature map information inverse-quantizer 3030 may perform the inverse operation of the operation performed by the feature map information quantizer 240. The information generated by the feature map information quantizer 240 may be information input to the feature map information inverse-quantizer 3030. The information input to the feature map information quantizer 240 may be information generated by the feature map information inverse-quantizer 3030. The information used for the operation in the feature map information quantizer 240 may also be used for the inverse operation in the feature map information inverse-quantizer 3030.

In an embodiment, the feature map information inverse-packer 3020 may perform the inverse operation of the operation performed by the feature map information packer 250. The information generated by the feature map information packer 250 may be information input to the feature map information inverse-packer 3020. The information input to the feature map information packer 250 may be information generated by the feature map information inverse-packer 3020. The information used for the operation in the feature map information packer 250 may also be used for the inverse operation in the feature map information inverse-packer 3020.

In an embodiment, the feature map information decoder 3010 may perform the inverse operation of the operation performed by the feature map information encoder 260. The information generated by the feature map information encoder 260 may be information input to the feature map information decoder 3010. The information input to the feature map information encoder 260 may be information generated by the feature map information decoder 3010. The information used for the operation in the feature map information encoder 260 may also be used for the inverse operation in the feature map information decoder 3010.

In the embodiments, the information derived by the encoding apparatus 110 may be provided to the decoding apparatus 120 through the bitstream, and the decoding apparatus 120 may perform the above-described inverse operations using the information extracted from the bitstream.

For example, as the inverse operation of the operation described above with reference to FIGS. 5 and 6, the feature map inverse-transformer 3040 may generate a (reconstructed) feature map by performing an inverse transform on a transform coefficient based on a basis vector.

For example, as the inverse operation of the operation described above with reference to FIGS. 14 and 15, the feature map inverse-transformer 3040 may generate a (reconstructed) feature map by performing an inverse transform on a transform coefficient based on a fixed basis vector.

For example, as the inverse operation of the operation described above with reference to FIGS. 16 and 17, the feature map inverse-transformer 3040 may generate a (joined) feature map by performing an inverse transform on a common transform coefficient based on a fixed common basis vector. Here, the joined feature map may be separated into multiple feature maps. Upsampling or downsampling may be applied to some of the multiple separated feature maps. Here, upsampling or downsampling applied by the feature map inverse-transformer 3040 may be the inverse operation of the downsampling or upsampling operation applied by the feature map transformer 230 or the downsampling unit 1220.

For example, as the inverse operation of the operation described above with reference to FIGS. 18 and 19, the feature map inverse-transformer 3040 may generate a (reconstructed) feature map by performing an inverse transform on a basis vector based on a fixed transform coefficient.

For example, as the inverse operation of the operation described above with reference to FIGS. 20 and 21, the feature map inverse-transformer 3040 may generate a (joined) feature map by performing an inverse transform on a common basis vector based on a fixed common transform coefficient. Here, the joined feature map may be separated into multiple feature maps. Upsampling or downsampling may be applied to some of the multiple separated feature maps. Here, upsampling or downsampling applied by the feature map inverse-transformer 3040 may be the inverse operation of the downsampling or upsampling operation applied by the feature map transformer 230 or the downsampling unit 1220.

For example, as the inverse operation of the operation described above with reference to FIGS. 22 and 23, the feature map information decoder 3010 may reconstruct a differential basis vector by performing decoding on an encoded differential basis vector. The feature map information decoder 3010 or the feature map inverse-transformer 3040 may reconstruct a basis vector by adding a fixed basis vector to a (reconstructed) differential basis vector.

For example, as the inverse operation of the operation described above with reference to FIGS. 24 and 25, the feature map information decoder 3010 may reconstruct a common differential basis vector by performing decoding on an encoded common differential basis vector. The feature map information decoder 3010 or the feature map inverse-transformer 3040 may reconstruct a common basis vector by adding a fixed common basis vector to a (reconstructed) common differential basis vector.

For example, as the inverse operation of the operation described above with reference to FIGS. 26 and 27, the feature map information decoder 3010 may reconstruct a differential transform coefficient by performing decoding on an encoded differential transform coefficient. The feature map information decoder 3010 or the feature map inverse-transformer 3040 may reconstruct a transform coefficient by adding a fixed transform coefficient to a (reconstructed) differential transform coefficient.

For example, as the inverse operation of the operation described above with reference to FIGS. 26 and 27, the feature map information decoder 3010 may reconstruct a common differential transform coefficient by performing decoding on an encoded common differential transform coefficient. The feature map information decoder 3010 or the feature map inverse-transformer 3040 may reconstruct a transform coefficient by adding a fixed common transform coefficient to a (reconstructed) common differential transform coefficient.

In embodiments, the decoding apparatus 120 may perform an operation corresponding to the operation in the encoding apparatus 110. The decoding apparatus 120 may generate information described as being generated by the encoding apparatus 110 by performing the operation corresponding to the operation in the encoding apparatus 110.

For example, based on the method described above with reference to FIGS. 7 to 13, the feature map information inverse-transformer 3040 may derive a common transform coefficient and/or a common basis vector.

The above-described embodiments may be performed on a luma signal and a chroma signal, respectively. The above-described embodiments may be equally performed on the luma signal and the chroma signal, respectively.

The form of each block to which the embodiments are to be applied may have a square form or a non-square form.

Whether at least one of the above-described embodiments is to be applied and/or performed may be determined based on a condition related to the size of a block. In other words, at least one of the above-described embodiments may be applied and/or performed when the condition related to the size of a block is satisfied. The condition includes a minimum block size and a maximum block size. The block may be one of blocks described above in connection with the embodiments and the units described above in connection with the embodiments. The block to which the minimum block size is applied and the block to which the maximum block size is applied may be different from each other.

For example, when the block size is equal to or greater than the minimum block size and/or less than or equal to the maximum block size, the above-described embodiments may be applied and/or performed. When the block size is greater than the minimum block size and/or less than or equal to the maximum block size, the above-described embodiments may be applied and/or performed.

For example, the above-described embodiments may be applied only to the case where the block size is a predefined block size. The predefined block size may be 2×2, 4×4, 8×8, 16×16, 32×32, 64×64, or 128×128. The predefined block size may be (2*SIZE_{X})×(2*SIZE_{Y}). SIZE_{X} may be one of integers of 1 or more. SIZE_{Y} may be one of integers of 1 or more.

For example, the above-described embodiments may be applied only to the case where the block size is equal to or greater than the minimum block size. The above-described embodiments may be applied only to the case where the block size is greater than the minimum block size. The minimum block size may be 2×2, 4×4, 8×8, 16×16, 32×32, 64×64, or 128×128. Alternatively, the minimum block size may be (2*SIZE_{MIN_X})×(2*SIZE_{MIN_Y}). SIZE_{MIN_X} may be one of integers of 1 or more. SIZE_{MIN_Y} may be one of integers of 1 or more.

For example, the above-described embodiments may be applied only to the case where the block size is less than or equal to the maximum block size. The above-described embodiments may be applied only to the case where the block size is less than the maximum block size. The maximum block size may be 2×2, 4×4, 8×8, 16×16, 32×32, 64×64, or 128×128. Alternatively, the maximum block size may be (2*SIZE_{MAX_X})×(2*SIZE_{MAX_Y}). SIZE_{MAX_X} may be one of integers of 1 or more. SIZE_{MAX_Y} may be one of integers of 1 or more.

For example, the above-described embodiments may be applied only to the case where the block size is equal to or greater than the minimum block size and is less than or equal to the maximum block size. The above-described embodiments may be applied only to the case where the block size is greater than the minimum block size and is less than or equal to the maximum block size. The above-described embodiments may be applied only to the case where the block size is equal to or greater than the minimum block size and is less than the maximum block size. The above-described embodiments may be applied only to the case where the block size is greater than the minimum block size and is less than the maximum block size.

In the above-described embodiments, the block size may be a horizontal size (width) or a vertical size (height) of a block. The block size may indicate both the horizontal size and the vertical size of the block. The block size may indicate the area of the block. Each of the area, minimum block size, and maximum block size may be one of integers equal to or greater than 1. In addition, the block size may be the result (or value) of a well-known equation using the horizontal size and the vertical size of the block, or the result (or value) of an equation in embodiments.

Further, in the foregoing embodiments, a first embodiment may be applied to a first size, and a second embodiment may be applied to a second size.

The foregoing embodiments may be applied depending on a temporal layer. In order to identify a temporal layer to which the embodiments are applicable, a separate identifier may be signaled, and the embodiments may be applied to the temporal layer specified by the corresponding identifier. Here, the identifier may be defined as the lowermost layer and/or the uppermost layer to which the embodiments are applicable, and may be defined as indicating a specific layer to which the embodiments are applied. Further, a fixed temporal layer to which the embodiments are applied may also be defined.

For example, the embodiments may be applied only to the case where the temporal layer of a target image is the lowermost layer. For example, the embodiments may be applied only to the case where the temporal layer identifier of the target image is equal to or greater than 1. For example, the embodiments may be applied only to the case where the temporal layer of the target image is the uppermost layer.

A slice type or a tile group type to which the above-described embodiments are applied may be defined, and the above-described embodiments may be applied depending on the corresponding slice type or the tile group type.

In the above-described embodiments, it may be construed that, when specific processing is applied to a specific target, specified conditions may be required. Also, it may be construed that, when a description is made such that the specific processing is performed under specified determination, whether the specified conditions are satisfied may be determined based on a specified coding parameter and that, alternatively, when a description is made such that specific determination is made based on a specific coding parameter, the specific coding parameter may be replaced with an additional coding parameter. In other words, it may be considered that a coding parameter that influences the specific condition or the specific determination is merely exemplary, and it may be understood that, in addition to the specified coding parameter, a combination of one or more coding parameters functions as the specified coding parameter.

In the above-described embodiments, although the methods have been described based on flowcharts as a series of steps or units, the present disclosure is not limited to the sequence of the steps and some steps may be performed in a sequence different from that of the described steps or simultaneously with other steps. Further, those skilled in the art will understand that the steps shown in the flowchart are not exclusive and may further include other steps, or that one or more steps in the flowchart may be deleted without departing from the scope of the disclosure.

The above-described embodiments include various aspects of examples. Although not all possible combinations for indicating various aspects can be described, those skilled in the art will recognize that additional combinations other than the explicitly described combinations are possible. Therefore, it may be appreciated that the present disclosure includes all other replacements, changes, and modifications belonging to the accompanying claims.

The above-described embodiments according to the present disclosure may be implemented as a program that can be executed by various computer means and may be recorded on a computer-readable storage medium. The computer-readable storage medium may include program instructions, data files, and data structures, either solely or in combination. Program instructions recorded on the storage medium may have been specially designed and configured for the present disclosure, or may be known to or available to those who have ordinary knowledge in the field of computer software.

The computer-readable storage medium may include information used in embodiments according to the present disclosure. For example, the computer-readable storage medium may include a bitstream, which may include various types of information described in the embodiments of the present disclosure.

The bitstream may include computer-executable code and/or program. The computer-executable code and/or program may include pieces of information described in embodiments, and may include syntax elements described in the embodiments. In other words, pieces of information and syntax elements described in embodiments may be regarded as computer-executable code in a bitstream, and may be regarded as at least part of computer-executable code and/or program represented by a bitstream. The computer-readable storage medium may include a non-transitory computer-readable medium.

Examples of the computer-readable storage medium include all types of hardware devices specially configured to record and execute program instructions, such as magnetic media, such as a hard disk, a floppy disk, and magnetic tape, optical media, such as compact disk (CD)-ROM and a digital versatile disk (DVD), magneto-optical media, such as a floptical disk, ROM, RAM, and flash memory. Examples of the program instructions include machine code, such as code created by a compiler, and high-level language code executable by a computer using an interpreter. The hardware devices may be configured to operate as one or more software modules in order to perform the operation of the present disclosure, and vice versa.

There are provided a method, an apparatus and a storage medium for encoding/decoding a transform-based feature map.

There is provided transform-based encoding on one or more feature maps that are the targets of compression.

There is provided a method for extracting an optimal basis vector from one or more feature maps and acquiring a transform coefficient through a transform that uses the basis vector.

There is provided a method for transmitting a bitstream including a basis vector and a transform coefficient.

There is provided a method for receiving a bitstream including a basis vector and a transform coefficient.

There is provided a method for acquiring a decoded basis vector and a decoded coefficient from a bitstream.

There is provided a method for generating one or more reconstructed feature maps from a bitstream using a decoded basis vector and a decoded coefficient.

There is provided a method for deriving the final result of a deep-learning network through a machine vision task executer that uses a reconstructed feature map.

A fixed common basis vector or a fixed common transform coefficient may be used for one or more feature maps, and thus the amount of encoded data may be reduced, and encoding efficiency may be improved.

A fixed common basis vector or a fixed common transform coefficient, which is defined through an agreement between an encoding apparatus and a decoding apparatus, may be used, and thus encoding errors in a basis vector and/or a transform coefficient that occur in a conventional transform-based encoding method may be reduced, and encoding efficiency may be improved.

As described above, although the present disclosure has been described based on specific details such as detailed components and a limited number of embodiments and drawings, those are merely provided for easy understanding of the entire disclosure, the present disclosure is not limited to those embodiments, and those skilled in the art will practice various changes and modifications from the above description.

Accordingly, it should be noted that the spirit of the present embodiments is not limited to the above-described embodiments, and the accompanying claims and equivalents and modifications thereof fall within the scope of the present disclosure.

What is claimed is:

1. An encoding method, comprising:
extracting a feature map from an input image;
acquiring feature map information from the feature map; and
generating a bitstream by performing encoding on the feature map information.

2. The encoding method of claim 1, wherein the feature map information includes at least one of a basis vector or a transform coefficient, or a combination thereof.

3. The encoding method of claim 1, wherein:
a basis vector of the feature map is derived using the feature map, and
a transform coefficient is derived by performing a transform on the feature map based on the basis vector.

4. The encoding method of claim 1, wherein a fixed basis vector of the feature map is derived using the feature map information, and a transform that uses the fixed basis vector is performed on the feature map.

5. The encoding method of claim 4, wherein a common transform coefficient is generated by performing the transform that uses the fixed basis vector on the feature map. and

6. The encoding method of claim 4, wherein:
a joined feature map is generated by joining multiple reconfigured feature maps, and
the joined feature map is used to derive the fixed basis vector.

7. The encoding method of claim 1, wherein at least one of quantization or packing, or a combination thereof is performed on the feature map information.

8. The encoding method of claim 7, wherein at least one of the quantization or the packing, or a combination thereof is skipped depending on a type of the feature map information.

9. The encoding method of claim 1, wherein the feature map includes multiple feature maps having different resolutions.

10. A computer-readable storage medium for storing a bitstream generated by the encoding method of claim 1.

11. A decoding method, comprising:
acquiring feature map information from a bitstream; and
acquiring a feature map from the feature map information.

12. The decoding method of claim 11, wherein the feature map information includes at least one of a basis vector or a transform coefficient, or a combination thereof.

13. The decoding method of claim 12, wherein the feature map is reconstructed by performing an inverse transform that uses at least one of the basis vector or the transform coefficient, or a combination thereof.

14. The decoding method of claim 11, wherein the feature map is reconstructed by performing an inverse transform that uses at least one of a fixed basis vector or a fixed transform coefficient of the feature map, or a combination thereof.

15. The decoding method of claim 14, wherein the bitstream includes at least one of the fixed basis vector or the fixed transform coefficient, or a combination thereof.

16. The decoding method of claim 11, wherein at least one of inverse packing or inverse quantization or a combination thereof is performed on the feature map information.

17. The decoding method of claim 16, wherein at least one of the inverse-quantization or the inverse-packing or a combination thereof is skipped depending on a type of the feature map information.

18. The decoding method of claim 11, wherein the feature map includes multiple feature maps having different resolutions.

19. The decoding method of claim 11, further comprising:
deriving a result of a deep-learning network by executing a machine-vision task using the feature map.

20. A computer-readable storage medium for storing a bitstream for image decoding, wherein:
the bitstream includes feature map information, and
a feature map is acquired from the feature map information.
